(19) United States
(12) Patent Application Publication
(10) Pub. No.: US 2024/0243913 A1
(43) Pub. Date: Jul. 18, 2024

(54) CUSTOMERS KEY PROTECTION FOR CLOUD NATIVE DEPLOYMENTS

(71) Applicant: Intel Corporation, Santa Clara, CA (US)

(72) Inventors: Junyuan WANG, Shanghai (CN); Kapil SOOD, Washougal, WA (US); Brian WILL, Phoenix, AZ (US); Thomas Joseph O'DWYER, Cashel (IE); Zijuan FAN, Shanghai (CN); Kaijie GUO, Shanghai (CN); Maksim LUKOSHKOV, Clarecastle (IE); Seosamh O'RIORDAIN, Ennis (IE); Jun XU, Shanghai (CN); Guodong ZHU, Shanghai (CN); Siming WAN, Shanghai (CN)

(21) Appl. No.: 18/560,368

(22) PCT Filed: Nov. 23, 2021
(86) PCT No.: PCT/CN2021/132504

§ 371 Date: Nov. 10, 2023

(51) Int. Cl. H04L 9/30

(52) U.S. Cl. CPC H04L 9/3066; H04L 9/302

(57) ABSTRACT

Methods and apparatus for customers key protection for cloud native deployments. Compute resources for a compute platform comprising platform hardware including one or more processors are allocated to one or more customers that use the compute resources to execute applications and/or services used to perform customer workloads. The compute platform includes a per-part device key that is used to generate hardware protected key used by the applications and services. Mechanisms are provided to ensure hardware protected keys can only be accessed by associated customers and/or customer applications and services, while preventing other customers and/or applications and services from accessing the hardware protected keys. The hardware protected keys include keys employing various forms of RSA and ECC Wrapped Private Keys (WPKs) including RSA WPKs, RSA Chinese Remainder Theorem CRT WPK and ECC WPKs.

### BACKGROUND INFORMATION

The use of cloud hosted infrastructure (e.g., Infrastructure as a Service (IaaS)) is platforms (e.g., Platform as a Service (PaaS) has seen rapid growth in the past few years. Communication Service Provider (CoSP) cloud operators provide IaaS and PaaS environments that are leased by telecommunication companies. Thus, the operators of the infrastructures and platforms and the IaaS and PaaS users are not the same. This creates potential security issues.

One problem is that as customers Workloads—whether they may be enterprise workloads or CoSP's 5G Service Based Architecture (SBA) Control plane or Data Plane (packet processing)—require private keys to be protected when they are running in different environments. The NFV (Network Function Virtualization) and 5G SBA allows CoSPs to run these functions in their own premise, but increasingly, these will be run in third party hosted Edge and in CSP or IaaS/PaaS environments. In each of these cases, the customers want to ensure that their Workload's private key is hardware protected.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating an abstracted view of KPT's key protection hierarchy;

FIG. 2 is a schematic diagram illustrating selected elements of an architecture for a run PKE service with a KPT protected private key.

FIG. 3 is a diagram illustrating an example of a KPT deployment in a CN environment;

FIG. 4 is a diagram illustrating a process using an RSA algorithm to generate an RSA Wrapped Private Key (WPK), according to one embodiment;

FIG. 5 is a diagram illustrating a process for generating an RSA Chinese Remainder Theorem (CRT) WPK, according to one embodiment;

FIG. 6 is a diagram illustrating a process for generating an RSA/ECC WPK, according to one embodiment;

FIG. 7 is a diagram illustrating a process for performing KPT Elliptic Curve Digital Signature Algorithm (ECDSA) signature with an RSA/ECC WPK;

FIG. 8 is a diagram illustrating a key protection mechanism employing a Wrapping Key Table (WKT) in a KPT device;

FIG. 9 is a diagram illustrating a multi-socket platform in which a shim layer is implemented to provide secure access to SWKs using key handles;

FIG. 10 is a combined message flow diagram and flowchart depicting operations performed by a service and KPT hardware and firmware to recode a service PASID into a WKT during key provisioning, according to one embodiment;

FIG. 11 is a flowchart illustrating operations and logic associated with key usage and deletion, according to one embodiment;

FIG. 12 is a flowchart illustrating operations performed to perform key cleanup associated with a PASID reset;

FIG. 13 is a flowchart illustrating operations performed by a cloud native deployment to build a service instance mapping table, according to one embodiment; and

FIG. 14 is a diagram of a compute platform or server that may be used to implement aspects of the embodiments described and illustrated herein.

### DETAILED DESCRIPTION

Embodiments of methods and apparatus for customers key protection for cloud native deployments are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

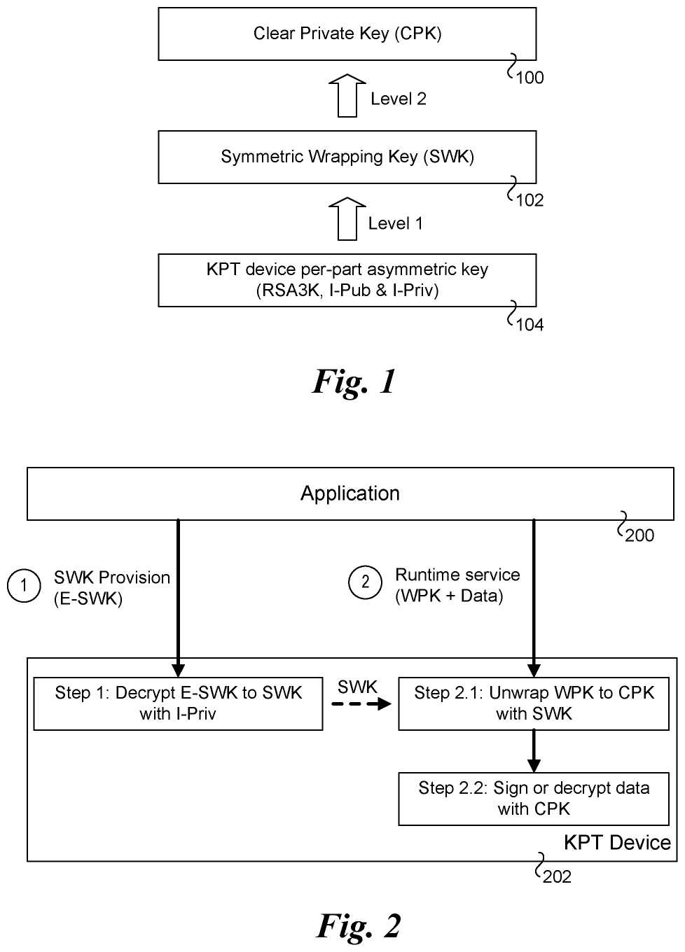

To have a better understanding of the solutions disclosed by embodiments herein, a brief primer on Intel® Key Protection Technology (KPT) is provided. An abstracted view of KPT's key protection hierarchy is shown in FIG. 1. A core idea of KPT is to build a two-level key protection hierarchy based on KPT device per-part asymmetric key. KPT per-part device key is device's permanent secret which is burned into the Intel CPU's internal fuses during manufacture. The per-part key's private key I-Priv is invisible to external entities and encrypted with an RTL-based Global Key (GKEY) while on the CPU SoC. KPT's I-Pub can be queried by external entities. As FIG. 1 shows, user's sensitive Clear Private Key (CPK) 100 is wrapped to Wrapped Private Key (WPK) with a Symmetric Wrapping Key (SWK) 102, and SWK is encrypted by I-Pub to an encrypted SWK (E-SWK) 104.

FIG. 2 shows selected elements of an architecture for a run PKE service with a KPT protected private key. The top-level elements include an application 200 and a KPT device 202. In the KPT service run-time, application 200 will load an E-SWK with a request to KPT device 202 to provision an SWK from the E-SWK. In operation 1, the E-SWK is decrypted by the I-Priv private key to obtain a SWK, which is kept in KPT device 200's secure memory.

The provisioned SWK is used to unwrap following crypto service requests' WPK to CPK (operation 2.1), and CPK is used to perform crypto signing or decryption (operation 2.2).

KPT's level 1 protection hierarchy (as shown in FIG. 1) follows the standard crypto algorithm RSA3K-OAEP-256 to encrypt SWK to E-SWK:

$$E - SWK = RSA 3 K - OAEP - 256 \_Encrypt ( I - Pub , SWK )$$

KPT HW/FW will do the reverse operation to get a SWK with I-Priv at service runtime.

$$SWK = RSA 3 K - OAEP - 256 \_Decrypt ( I - Priv , E - SWK )$$

In level 2's protection, KPT takes a new private key wrapping schema to wrap a CPK, this schema can safeguard wrapped key's confidentiality and integrity, while reducing KPT hardware/firmware/software's implementation complexity.

Based on the 2-level key protection hierarchy, KPT introduced new key management enhancement to facilitate KPT deployment in cloud native (CN) environments, which can enable multiple services to consume a single KPT physical device simultaneously without any security and performance compromise.

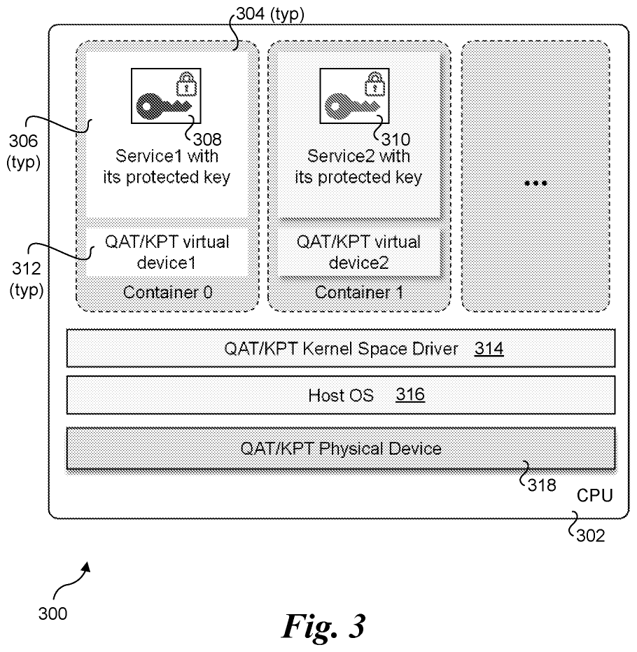

An example of a KPT deployment in a CN environment 300 is shown in FIG. 3. The CN environment includes a CPU 302 on which various software components are hosted, including containers 304, such as depicted by Container 0 and Container 1. A service 306 with an associated protected key 308 and 310 is run in Container 0 and Container 1, respectively. Each of Container 0 and Container 1 also include an Intel® Corporation's Quick Assist Technology (QAT)/KPT virtual device 312. As shown in the lower portion of FIG. 3, CN environment 300 further includes a QAT/KPT kernel space driver 314, a host operating system (OS) 316, and a QAT/KPT physical device 318.

Wrapping and unwrapping a crypto private key (e.g., in KPT's level 2 protection) in a resource constrained working environment without security and performance compromise is a challenge, as an asymmetric private key structure has a private part and lots of associated public information, which are necessities in private key signing/decryption operation. As a result, improper wrapping may introduce security vulnerabilities like invalid curve attack. Additionally, in a computing and storage resource constrained environment, a crypto device cannot handle the private key wrapping/unwrapping and encoding/decoding as flexible as general computing platform can.

Another challenge is the key management in a CN environment. Since one KPT device is consumed by multiple services, each service must have an exclusive key access privilege to its own keys, e.g., service A's provisioned key can only be access by service A itself.

Private key wrapping schema includes two kinds of asymmetric algorithms: RSA and Elliptic-curve cryptography (ECC). The RSA private key wrapping method and format is based on rfc 2437 (PKCS #1: RSA Cryptography Specifications Version 2.0), which specifies RSA CPK (Clear Private Key) ASN.1 (Abstract Syntax Notation One) type syntax shown below:

| RSAPrivateKey ::= SEQUENCE { | |
|---|---|
| version | Version, |
| modulus | INTEGER, -- n |
| publicExponent | INTEGER, -- e |
| privateExponent | INTEGER, -- d |
| prime1 | INTEGER, -- p |
| prime2 | INTEGER, -- q |
| exponent1 | INTEGER, -- d mod (p-1) |
| exponent2 | INTEGER, -- d mod (q-1) |
| coefficient | INTEGER, -- (inverse of q) mod p |
| otherPrimeInfos | OtherPrimeInfos OPTIONAL |

}

The KPT wrapping key schema employs AES256-GCM (Galois/Counter Mode) as the wrapping algorithm and implements the following operations to build a wrapped RSA private key structure.

For RSA Chinese Remainder Theorem (CRT) mode, prime1(p), prime2(q), exponent1(dP), exponent1(dQ), coefficient(qinv) and publicExponent(e) are concatenated together as a blob, and then the blob is encrypted with the Symmetric Wrapping Key (SWK). The Wrapped Private Key using the CRT mode (WPK_CRT) is obtained from:

$$WPK\_CRT = AES\_GCM ( SWK , ( p ‖ q ‖ dP ‖ dQ ‖ qInv ‖ e ) ) ;$$

For non-CRT mode, privateExponent(d) and modules(n) are concatenated together as a blob, and then the blob is encrypted with SWK, and the WPK is obtained from:

$$WPK = AES\_GCM ( SWK , ( d ‖ n ) ) ;$$

A 128-bit AES256-GCM Authentication (Auth) tag is appended to the end of WPK cipher text for each of the RSA CRT mode and non-CRT mode.

The RSA algorithm's object ID (OID) value, e.g., “1.2.840.113549.1.1” is used as additional authenticated data (AAD) for AES256-GCM wrapping and unwrapping. Combined with other public information, the final KPT RSA WPK structure is defined in TABLE 1.

TABLE 1

| NO. | Name | Type | Comments |
|---|---|---|---|
| 0 | version | INTEGER | KPT WPK version |
| 1 | WrappedPrivateKey | OCTET | (d\|\|n)′\|\|auth |
| | | STRING | |
| 2 | WrappedCRTPrivateKey | OCTET | (p\|\|q\|\|dp\|\|dq\|\|qinv\|\|e)′\|\|auth |
| | | STRING | |
| 3 | KeySize | INTEGER | 512/1024/1536/2048/3072/4096/8192 |
| 4 | KptRsaDsi | OBJECT | AAD used for KPT private key wrapping: |
| | | IDENTIFIER | WPK = AES256-GCM (SWK, CPK, IV, |
| | | | AAD) |
| 5 | N | OCTET | User CPK's public key, following |
| | | STRING | PKCS#1's convention. |
| | E | OCTET | |
| | | STRING | |
| 6 | AesNonce | OCTET | IV used in private key wrapping |
| | | STRING | WPK = AES256-GCM (SWK, CPK, IV, |
| | | | AAD) |
| 7 | WrappingAlg | OBJECT | OID of AES256-GCM |
| | | IDENTIFIER | |
| 8 | E-SWK | OCTET | Encrypted SWK. |
| | | STRING | E-SWK = RSA3K_OAEP(I-Pub, SWK) |

The ECC private key wrapping method and format is based on rfc5915 (Elliptic Curve Private Key Structure) and rfc5480 (Elliptic Curve Cryptography Subject Public Key Information), which specifies ECC CPK ASN.1 type syntax as follows:

```
ECPrivateKey ::= SEQUENCE {
    version INTEGER { ecPrivkeyVer1(1) } (ecPrivkeyVer1),
    privateKey OCTET STRING,
    parameters [0] ECParameters {{ NamedCurve }} OPTIONAL,
    publicKey [1] BIT STRING OPTIONAL
  }
ECParameters ::= CHOICE {
      namedCurve OBJECT IDENTIFIER
      -- implicitCurve NULL
      -- specifiedCurve SpecifiedECDomain
    }
```

KPT wrapping key schema employs AES256-GCM as the wrapping algorithm and implements the following operations to build a wrapped ECC private key structure.
1. Hardcoded elliptic curve parameters: p, a, b, G, n, h in firmware, firmware will query corresponding curve parameters by input curve OID to perform crypto signing.
2. Encrypt privateKey field only and take curve OID as AAD in AES256-GCM wrapping.

Using the foregoing, WPK is calculated as:

$$WPK = AES\_GCM ( SWK , d , Curve\_OID ) .$$

Any incorrect input curve OID will cause WPK unwrapping to fail, thus help defend against any possible DOS attack and invalid curve attack. Combined with other public information, the final KPT ECC WPK structure is defined in TABLE 2.

TABLE 2

| NO. | Name | Type | Comments |
|---|---|---|---|
| 0 | version | INTEGER | KPT WPK version |
| 1 | WrappedPrivateKey | OCTET STRING | (d)′\|\|auth |
| 2 | Curve_OID | OBJECT | Curve OID, used as AAD in private |
| | | IDENTIFIER | key wrapping |
| | | | WPK = AES256-GCM (SWK, |
| | | | CPK, IV, AAD) |
| 3 | Public Key | OCTET STRING | User CPK's public key, following |
| | | | rfc5919's convention. |
| 4 | AesNonce | OCTET STRING | IV used in private key wrapping |
| | | | WPK = AES256-GCM (SWK, |
| | | | CPK, IV, AAD) |
| 5 | WrappingAlg | OBJECT | OID of AES256-GCM |
| | | IDENTIFIER | |
| 6 | E-SWK | OCTET STRING | Encrypted SWK. |
| | | | E-SWK = RSA3K_OAEP (I-Pub, |
| | | | SWK) |

### Asymmetric Private Key Protection

Instead of wrapping, unwrapping, and decoding a whole ASN.1 encoded private key structure, our schema takes a light but secure wrapping approach that employs AES256-GCM as a wrapping algorithm to encrypt the private key parts of the private key structure only, while also employing a mechanism to safeguard the public info's integrity.

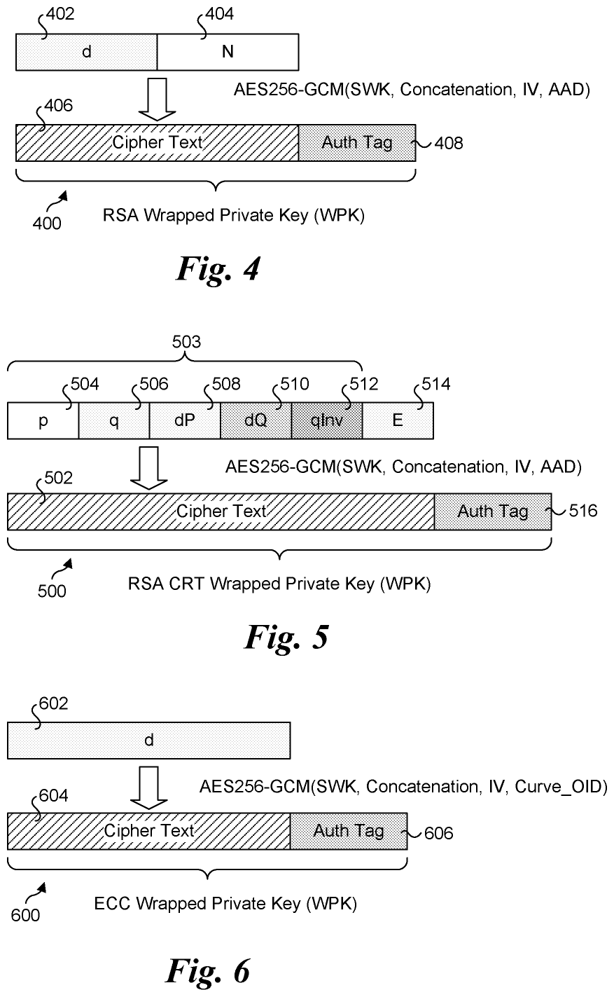

An example of this process using an RSA algorithm to generate an RSA WPK 400 is shown in FIG. 4. A concatenation of private key 402 (d) and modules 404 (N) is wrapped with a symmetric cryptographic algorithm (e.g., AES256-GCM in this example) to generate cipher text 406 to which an Authentication (Auth) tag 408 is appended. N is not a secret here, but its integrity should be checked as a tampered N can decrease computational complexity, then introduce private leakage vulnerabilities. To simplify the hardware/firmware implementation, N is wrapped with d together.

A process for generating an RSA Chinese Remainder Theorem (CRT) WPK 500 is shown in FIG. 5. Cipher text 502 is generated by applying the AES256-GCM algorithm using the SWK to a private key blob 503 including prime1(p) 504, prime2(q) 506, exponent1(dP) 508, exponent1(dQ) 510, coefficient(qInv) 512 is concatenated with a public exponent E 514, and is further concatenated with an AcsNonce comprising an IV and an object identifier comprising an RsaDsi (see TABLE 1 above). An Auth tag 516 is appended to cipher text 502 to complete RSA CRT WPK 500. As with N above, public exponent E is not a secret here, but its integrity should be checked as a tampered E can decrease computational complexity. To simplify the hardware/firmware implementation, E is wrapped with the private key blob 503.

An example of the process for generating an ECC WPK 600 is shown in FIG. 6. For ECC, the private key d (602) of the key structure is wrapped using the AES256-GCM algorithm and the SWK but hardcodes public information like the ECC curve parameters (called the curve OID or Curve_OID in FIG. 6) in the QAT device firmware to defend against invalid curve attacks. As before, the AES256-GCM is a non-limiting example of a symmetric cryptographic algorithm that is used in one embodiment. The wrapping generates cipher text 604 to which an Auth tag 606 is appended. The QAT device firmware is signed by the device vendor and verified through a hardware root of trust inside the QAT IP (Intellectual Property) block to ensure that it has not been tampered.

Consider a curve OID as AAD in an AES256-GCM wrapping. An incorrect curve OID input from the KPT service request will cause a WPK unwrapping failure, which can help defend against DOS attack.

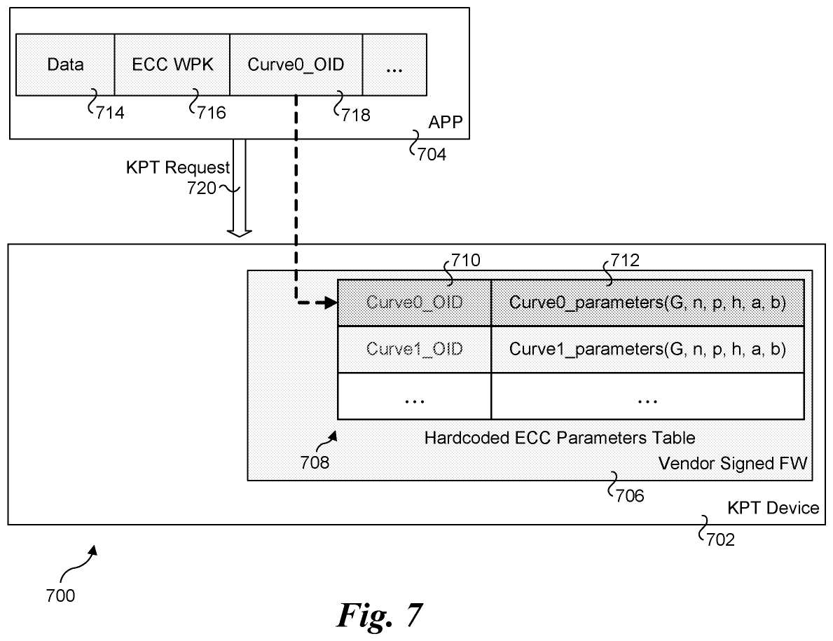

Diagram 700 of FIG. 7 shows a process for performing KPT Elliptic Curve Digital Signature Algorithm (ECDSA) signing with an ECC WPK. The top-level components include a KPT device 702 and an application 704. KPT device 702 includes vendor signed firmware (FW) 706 including a hardcoded ECC parameters table 708 including an ECC Curve_OID field 710 and an ECC Curve parameters field 712. The data in hardcoded ECC parameters table 708 are hardcoded in the KPT device firmware and cannot be changed. Application 704 produces data 714, an ECC WPK 716, a Curve0_OID 718 and other optional data. Application 704 submits a KPT request 720 including Curve0_OID 718 to KPT device 702, which checks for a matching entry in hardcoded ECC parameters table 708 and returns the Curve parameters for the matching Curve0_OID entry. The Curve parameters are then used for ECC private key signing with ECC WPK 716.

### Key Management Enhancement

To ensure that a provisioned secret is only used by the Container/VM (virtual machine) that provisioned that secret, one embodiment binds and provides access control for using the secrets through the OS assigned PASID (Process Address Space Identifier). This prevents rogue Containers from accessing secrets inside the QAT/KPT.

A PASID is a unique identifier that is issued by an operating system and provides a connection between processes/threads and where they reside in memory, which enables various platform hardware and software to share access to a process's/thread's memory address space. The use of the term “PASID” is used generically herein to represent a unique identifier that associates a memory address space with a process or thread.

The embodiment's design associates the service's PASID to its provisioned SWK (e.g., see operation 1 in FIG. 2), wherein the PASID is assigned by the OS and Virtual Machine Monitor (VMM) (in a virtualization environment) and is a unique value. Under security provisions in the OS, user space processes do not have privilege to modify a PASID.

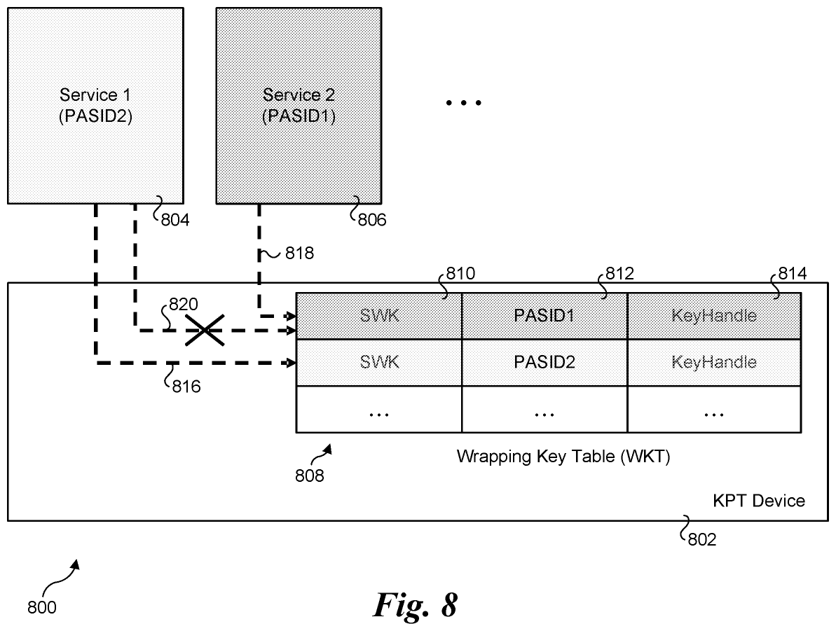

When the PASID check is turned ON in deployments (e.g., for Cloud Service Providers who are running multiple tenants on the same CPU using the same QAT/KPT device), the KPT hardware is enabled to access a process's PASID in the key provision, and record the PASID in a SWK entry. This happens at the higher privileged OS levels and cannot be tampered with by the Containers or VMs. In service runtime when the Container needs to access its secrets in QAT/KPT, only the process whose PASID is identical to the value obtained from the SWK entry has SWK access privilege, as illustrated in diagram 800 of FIG. 8 and described below. A rogue Container trying to access secrets of a different Container will be rejected by QAT/KPT, which will detect an incorrect PASID associated with that rogue Containers' request. As discussed above, the Container cannot choose or alter its PASID, because PASID is handled entirely by higher privileged OS/VMM.

As shown in diagram 800, a KPT device 802 receives access requests from a pair of services 804 and 806 (Service 1 and Service 2) with respective PASIDs PASID2 and PASID1. KPT includes a Wrapping Key Table (WKT) 808 including an SWK field 810, a PASID field 812, and a KeyHandle table 814.

Diagram 800 shows two access attempts 816 and 818 of WKT 808 from Service 1 and Service 2 that are permitted, and a third access attempt 820 that is denied. Since Service 1 is associated with PASID2, Service 1 is permitted to access the second entry in WKT 808, which includes PASID2 in PASID field 812. Similarly, Service 2 is permitted to access the first entry in WKT 808. In contrast, when Service 1 attempts to access the first entry in WKT 808 it is denied as its PASID2 does not match PASID1 in PASID field 812.

To defend against replay attacks, KPT introduces a PASID reset mechanism, once service terminated (e.g., Container or a VM is terminated), a PASID reset will be triggered to the QAT/KPT device on the CPU, and the corresponding SWKs will be removed from the Wrapping Key Table (WKT). This ensures that the customers secrets are securely removed from the QAT/KPT device once the customer workload terminates on that CPU, and thereby, ensures that rogue Containers cannot use those secrets.

Scalable Use of QAT/KPT IP instances: The CPU/SoC may have 1 or more QAT/KPT IP instances, which creates a problem for configuring and using secrets on that CPU. For instance, a mainline CPU may have 4 instances of QAT/KPT, while different CPU/SoC may have 2 instances. The goal is to ensure that the customers can run their applications (Containers, Service Mesh, VMs, etc.) on the QAT/KPT without having underlying knowledge of QAT/KPT instances and how their keys were provisioned and used. This is done using instance agnostic software processing that allows applications to run their same software seamlessly across different CPUs, including CPUs with different instruction set architectures (ISAs).

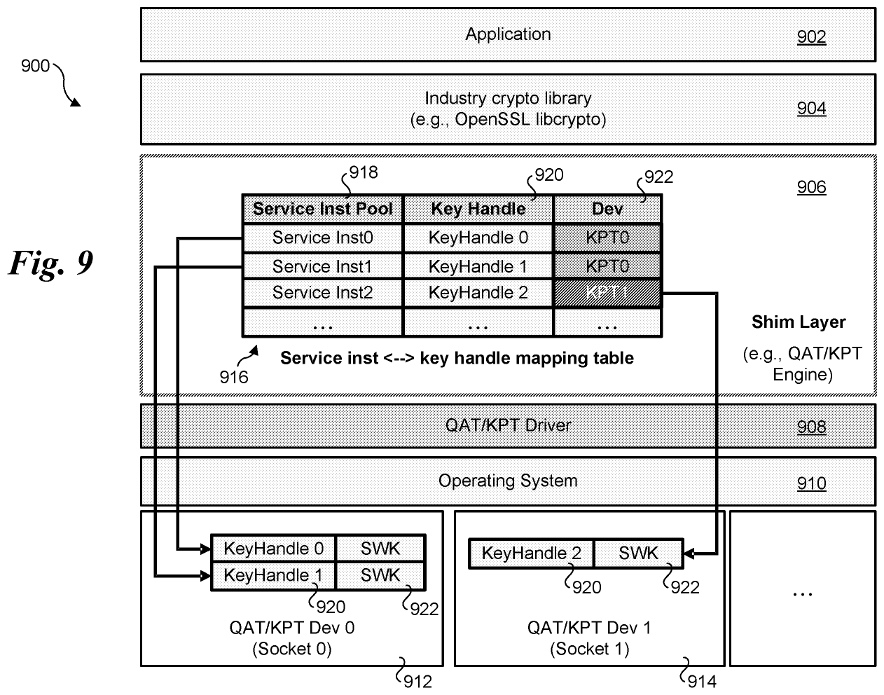

As shown in FIG. 9, a software shim layer is introduced to work as an API adaptor between an industry crypto library like OpenSSL Libcryto and the QAT/KPT service API. The shim will detect the platform's hardware capabilities and abstract the KPT capable hardware resources to a uniform service instance pool. It will further provision SWK for each service instance, and then build the mapping relationship between the service instance and its key handle. Meanwhile, all of the generated information is transparent to the upper layer application.

In further detail, FIG. 9 shows a multi-socket platform 900 including an application 902, and industry crypto library 904, a shim layer 906, a QAT/KPT driver 908, an operating system 910, and multiple QAT/KPT devices 912 and 914 also labeled QAT/KPT Dev 0 (on Socket 0) and QAT/KPT Dev 1 (on Socket 1). In one embodiment, shim layer 906 is implemented in a QAT/KPT engine.

Shim layer 906 includes a service instance—key handle mapping table 916 including a service instance pool field 918, a key handle field 920, and a device (Dev) field 922. For each service instance, there is a corresponding key handle 920 stored on the QAT/KPT device for the socket executing the service instance. As shown, KeyHandle 0 and KeyHandle 1 for Service Inst0 and Service Inst1 are stored on QAT/KPT Dev 0, while KeyHandle 2 is stored on QAT/KPT Dev 1. As further shown, each key handle 920 on QAT/KPT devices 912 and 914 has an associated SWK 922.

Generally, shim layer 906 and QAT/KPT driver layer 908 may be implemented in different software layers/components depending on the software architecture implement for a given compute platform. For instance, for a “bare metal” implementation, shim layer 906 and QAT/KPT driver layer 908 may be implemented in a Type-1 hypervisor or similar virtualization layer. For a VMM or Type-2 hypervisor architecture, shim layer 906 and QAT/KPT driver layer 908 may be implemented in a host OS or a VM. In a container-based architecture, shim layer 906 and QAT/KPT driver layer 908 may be implemented in the container virtualization layer, or in a container itself. In some embodiments, shim layer 906 and QAT/KPT driver layer 908 may be implemented in a secure enclave, such as but not limited to an SGX secure enclave.

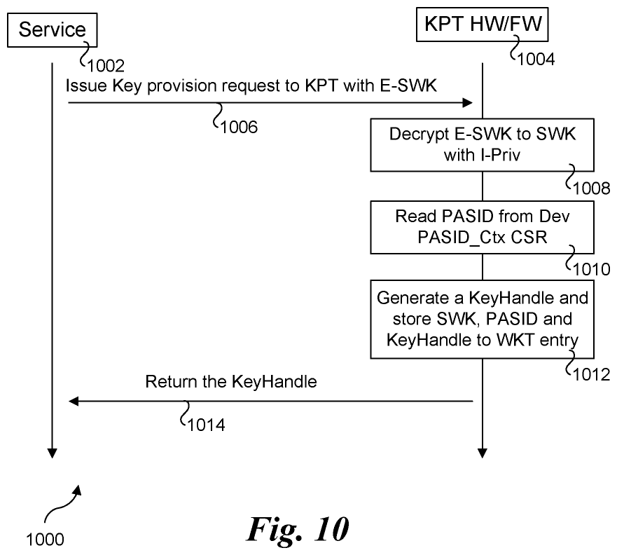

FIG. 10 shows a combined message flow diagram and flowchart 1000 which depicts operations performed by a service 1002 and KPT hardware and firmware (HW/FW) 1004 to record a service PASID into WKT during key provisioning. Service 1002 sends a message 1006 to KPT HW/SW 1004 comprising a key provision request with an E-SWK. In a block 1008, KTP HW/SW 1004 decrypts the E-SWK to extract a SWK with an I-Priv key.

In a block 1010, the PASID is read from the device's PASID_Ctx CSR (Control/Status Register). In a block 1012, a KeyHandle is generated and the SWK, PASID, and KeyHandle are added as a new WKT entry, similar to that shown in FIG. 8 and discussed above. KPT HW/FW 1004 then returns the KeyHandle to Service 1002 in a message 1014.

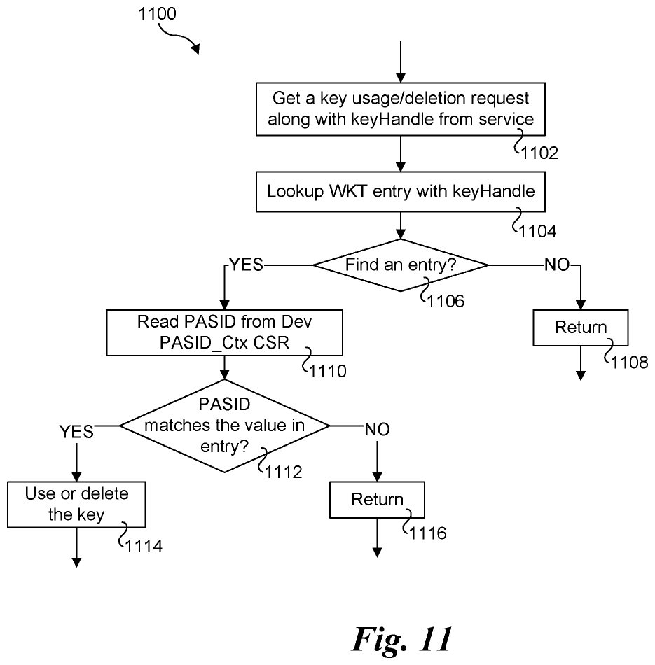

FIG. 11 shows a flowchart 1100 illustrating operations and logic associated with key usage and deletion. In a block 1102 a key usage deletion request is obtained along with a keyHandle from a service. In a block 1104, the WKT entry is looked up using the keyHandle. In a decision block 1106 a determination is made whether an entry matching the keyHandle is found. If no matching entry is found, the process returns, as shown by a return block 1108.

When a matching entry is found, the logic proceeds to a block 1110 in which the PASID is read from the PASID_CTx CSR. In a decision block 1112, a determination is made to whether the PASID matches the value in the WKT entry. If it does, the access is permitted, and the key is used or deleted, as shown in a block 1114. If the PASID does not match, the access is not permitted, and the process returns, as shown in a return block 1116.

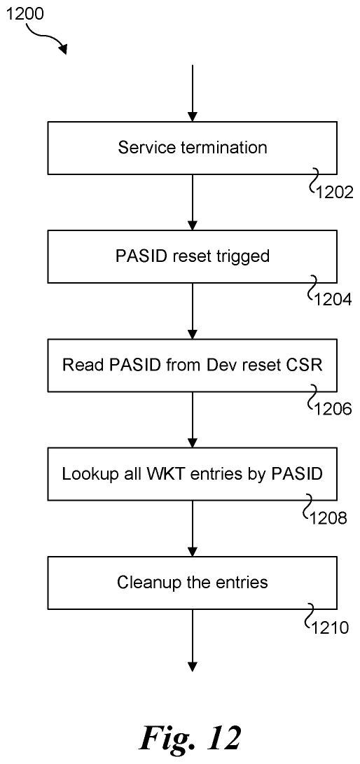

FIG. 12 shows a flowchart 1200 illustrating operations performed to perform key cleanup associated with a PASID reset. In a block 1202 a service termination is issued/received. In a block 1204 a PASID reset is triggered. In a block 1206, the PASID is read from the device's reset CSR. In a block 1208, all the WKT entries are looked up by PASID. Those entries matching the PASID are cleaned up by deleting them, as shown in a block 1210.

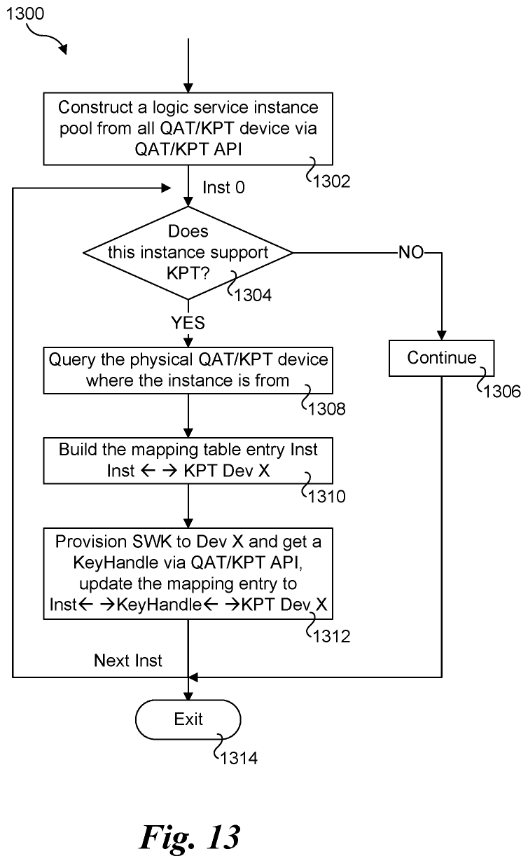

FIG. 13 shows a flowchart 1300 illustrating operations performed by a cloud native deployment to build a service instance mapping table. In a block 1302, a logic service instance pool is constructed from all QAT/KPT devices via the QAT/KPT API. We start with the first service instance (Inst 0), and iterate through until all service instances are processed using the following.

First, in a decision block 1304 a determination is made to whether the service instance supports KPT. If not, the logic proceeds to a continue block 1306 and proceeds to loop back to process the next service instance. When the service instance supports KPT, the logic proceeds to a block 1308 in which the physical QAT/KPT device is queried where the service instance is from. In a block 1310, the mapping table entry instance is built to map the service instance to the KTP device. In a block 1312 the SWK is provisioned to the device and a KeyHandle is obtained via the QAT/KPT API. The mapping entry is updated to now include the service instance, the KeyHandle, and the KPT device, such as shown by the mapping entries in service instance—key handle mapping table 916.

Upon completion of block 1312, the logic loops back to process the next service instance. The operations are iteratively performed for each service instance until all service instances are processed, at which point the process exits as depicted by an end block 1314.

The teachings and principles disclosed herein provide several advantages over existing approaches. These advantages include the following:

Security Across Customer SW deployments: This is applicable to the CN microservices model, in scenarios using a side-car approach or a mesh service termination. This is in addition to support for bare metal, Containers, VMs and standard process models.

API Security and Protecting Secrets while in-use: The private key wrapping schema can defend against all kinds of existing known security vulnerabilities.

Performance with Security: The private key wrapping schema simplifies KPT HW/FW's design and implementation, reduces HW/FW's cycles in WPK unwrapping and CPK decoding, and thus improves the crypto operation performance. This allows the software (e.g., Containers) to use QAT/KPT with a very minimal performance degradation, while the processing cycles are greatly reduced.

Access Control for Secrets inside QAT/KPT: Secure and high performance, PASID authentication/reset enhancement ensures only the key owner service can access its key and enables devices to handle a batch of requests at service runtime while not compromising performance.

Scalability of QAT Devices on CPU: Each CPU/SoC may have 1 or more QAT/KPT IP physical instances. The embodiments provide mechanisms to ensure that the microarchitecture complexity is not exposed to the customer software stacks.

### Example Platform/Server

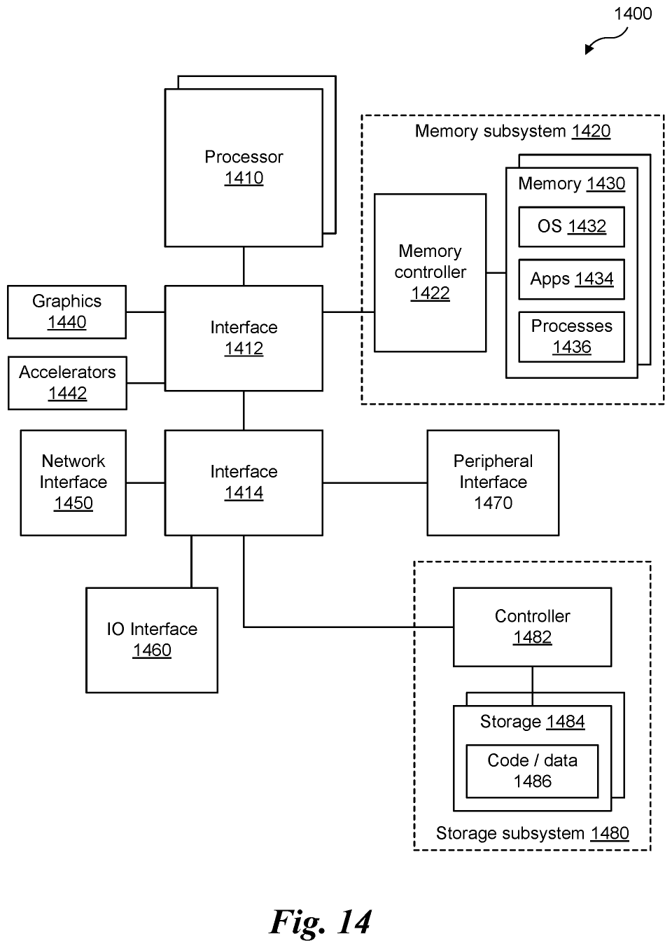

FIG. 14 depicts a compute platform 1400 such as a server, compute node, or similar computing system in which aspects of the embodiments disclosed above may be implemented. Compute platform 1400 includes one or more processors 1410, which provides processing, operation management, and execution of instructions for compute platform 1400. Processor 1410 can include any type of microprocessor, central processing unit (CPU), graphics processing unit (GPU), processing core, multi-core processor or other processing hardware to provide processing for compute platform 1400, or a combination of processors. Processor 1410 controls the overall operation of compute platform 1400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In some embodiments, processing may be split between a CPU and a GPU. For example, it is common to implement TensorFlow on compute platforms including a CPU and a GPU. In some embodiments the CPU and GPU are separate components. In other embodiments, a CPU and GPU may be implemented in a System on a Chip (SoC) or in a multi-chip module or the like.

In one example, compute platform 1400 includes interface 1412 coupled to processor 1410, which can represent a higher speed interface or a high throughput interface for system components that needs higher bandwidth connections, such as memory subsystem 1420 or optional graphics interface components 1440, or optional accelerators 1442. Interface 1412 represents an interface circuit, which can be a standalone component or integrated onto a processor die. Where present, graphics interface 1440 interfaces to graphics components for providing a visual display to a user of compute platform 1400. In one example, graphics interface 1440 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1440 generates a display based on data stored in memory 1430 or based on operations executed by processor 1410 or both. In one example, graphics interface 1440 generates a display based on data stored in memory 1430 or based on operations executed by processor 1410 or both.

In some embodiments, accelerators 1442 can be a fixed function offload engine that can be accessed or used by a processor 1410. For example, an accelerator among accelerators 1442 can provide data compression capability, cryptography services such as public key encryption (PKE), cipher, hash/authentication capabilities, decryption, or other capabilities or services. In some embodiments, in addition or alternatively, an accelerator among accelerators 1442 provides field select controller capabilities as described herein. In some cases, accelerators 1442 can be integrated into a CPU socket (e.g., a connector to a motherboard or circuit board that includes a CPU and provides an electrical interface with the CPU). For example, accelerators 1442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1442 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1420 represents the main memory of compute platform 1400 and provides storage for code to be executed by processor 1410, or data values to be used in executing a routine. Memory subsystem 1420 can include one or more memory devices 1430 such as read-only memory (ROM), flash memory, one or more varieties of random access memory (RAM) such as DRAM, or other memory devices, or a combination of such devices. Memory 1430 stores and hosts, among other things, operating system (OS) 1432 to provide a software platform for execution of instructions in compute platform 1400. Additionally, applications 1434 can execute on the software platform of OS 1432 from memory 1430. Applications 1434 represent programs that have their own operational logic to perform execution of one or more functions. Processes 1436 represent agents or routines that provide auxiliary functions to OS 1432 or one or more applications 1434 or a combination. OS 1432, applications 1434, and processes 1436 provide software logic to provide functions for compute platform 1400. In one example, memory subsystem 1420 includes memory controller 1422, which is a memory controller to generate and issue commands to memory 1430. It will be understood that memory controller 1422 could be a physical part of processor 1410 or a physical part of interface 1412. For example, memory controller 1422 can be an integrated memory controller, integrated onto a circuit with processor 1410.

While not specifically illustrated, it will be understood that compute platform 1400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, compute platform 1400 includes interface 1414, which can be coupled to interface 1412. In one example, interface 1414 represents an interface circuit, which can include standalone components and integrated circuitry. In one example, multiple user interface components or peripheral components, or both, couple to interface 1414. Network interface 1450 provides compute platform 1400 the ability to communicate with remote devices (e.g., servers or other computing devices) over one or more networks. Network interface 1450 can include an Ethernet adapter, wireless interconnection components, cellular network interconnection components, USB (universal serial bus), or other wired or wireless standards-based or proprietary interfaces. Network interface 1450 can transmit data to a device that is in the same data center or rack or a remote device, which can include sending data stored in memory. Network interface 1450 can receive data from a remote device, which can include storing received data into memory. Various embodiments can be used in connection with network interface 1450, processor 1410, and memory subsystem 1420.

In one example, compute platform 1400 includes one or more IO interface(s) 1460. IO interface 1460 can include one or more interface components through which a user interacts with compute platform 1400 (e.g., audio, alphanumeric, tactile/touch, or other interfacing). Peripheral interface 1470 can include any hardware interface not specifically mentioned above. Peripherals refer generally to devices that connect dependently to compute platform 1400. A dependent connection is one where compute platform 1400 provides the software platform or hardware platform or both on which operation executes, and with which a user interacts.

In one example, compute platform 1400 includes storage subsystem 1480 to store data in a nonvolatile manner. In one example, in certain system implementations, at least certain components of storage 1480 can overlap with components of memory subsystem 1420. Storage subsystem 1480 includes storage device(s) 1484, which can be or include any conventional medium for storing large amounts of data in a nonvolatile manner, such as one or more magnetic, solid state, or optical based disks, or a combination. Storage 1484 holds code or instructions and data 1486 in a persistent state (e.g., the value is retained despite interruption of power to compute platform 1400). Storage 1484 can be generically considered to be a “memory,” although memory 1430 is typically the executing or operating memory to provide instructions to processor 1410. Whereas storage 1484 is nonvolatile, memory 1430 can include volatile memory (e.g., the value or state of the data is indeterminate if power is interrupted to compute platform 1400). In one example, storage subsystem 1480 includes controller 1482 to interface with storage 1484. In one example controller 1482 is a physical part of interface 1414 or processor 1410 or can include circuits or logic in both processor 1410 and interface 1414.

Volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein can be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5), LPDDR5, HBM2E, HBM3, and HBM-PIM, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In an example, compute platform 1400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (ROCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

In the foregoing embodiments, the KPT devices comprises CPUs. However, this is merely exemplary and non-limiting, as the principles and techniques disclosed herein may also be applied to Other Processing Units (collectively termed XPUs) including one or more of Graphic Processor Units (GPUs) or General Purpose GPUs (GP-GPUs), Tensor Processing Units (TPUs), Data Processor Units (DPUs), Infrastructure Processing Units (IPUs), SmartNICs (network interface controllers), Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, as used in the following claims, the term “processor” is used to generically cover CPUs and various forms of XPUs.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (e.g., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

1.-25. (canceled)

26. A method implemented on a compute platform comprising platform hardware including one or more processors, comprising:
allocating, to one or more customers, compute resources provided by the platform hardware to facilitate execution of one or more customer applications and services used to perform one or more customer workloads;
provisioning, for a customer application or customer service, a hardware protected key that is generated using a per-part device key that is embedded in a hardware component on the platform; and
enabling the customer application or customer service to securely access the hardware protected key provisioned for the customer application or customer service while preventing any other customer application or customer service from accessing that hardware protected key.

27. The method of claim 26, wherein the hardware protected key comprises a Symmetric Wrapping Key (SWK).

28. The method of claim 27, further comprising generating an Elliptic-curve cryptography (ECC) wrapped private key (WPK) by:
applying an ECC algorithm using the SWK to a private key blob including a curve object identifier (Curve_OID) to generate cipher text; and
appending an authentication tag to the cipher text.

29. The method of claim 27, further comprising generating an RSA (Rivest-Shamir-Adleman) wrapped private key (WPK) by:
applying a symmetric cryptographic algorithm using the SWK to a private key blob to generate cipher text; and
appending an authentication tag to the cipher text.

30. The method of claim 29, wherein the RSA WPK comprises an RSA Chinese Remainder Theorem (CRT) WPK, and wherein the private key blob includes a concatenation of prime1(p), prime2(q), exponent1(dP), exponent1(dQ), coefficient(qinv) and publicExponent(e).

31. The method of claim 26, further comprising:
implementing a table including a plurality of entries, each entry including a unique identifier associated with an application or service instance and a key handle; and
enabling an application or service instance associated with a unique identifier to only access entries in the table with a matching unique identifier.

32. The method of claim 31, wherein the table is implemented in the hardware component including the per-part device key.

33. The method of claim 31, wherein the unique identifier associated with an application or service comprises a Process Address Space Identifier (PASID).

34. The method of claim 31, wherein the table comprises a first table and a key handle is used to access a hardware protected key stored on the hardware component having the per-part device key, further comprising:
implementing a second table mapping service instances to key handles; and
enabling a service instance to obtain a hardware protected key from the hardware component using the second table.

35. The method of any of the preceding claims, wherein the hardware component with the per-part device key comprises one of a central processing unit (CPU), a Graphic Processor Unit (GPU), a General Purpose GPU (GP-GPU), a Tensor Processing Unit (TPU), a Data Processor Unit (DPU), an Infrastructure Processing Units (IPU), a SmartNIC (network interface controllers), an Artificial Intelligence (AI) processor or an AI inference unit.

36. A compute platform, comprising:
one or more processors; and
a hardware component having a permanent per-part device key;
wherein the compute platform is configured to execute applications and/or services for multiple customers using compute resources including the one or more processors allocated to the multiple customers, and wherein the compute platform is further configured to,
provision, for a customer application or customer service, a hardware protected key that is generated using a per-part device key that is fused into a hardware component on the platform; and
enable a customer application or customer service to securely access the hardware protected key provisioned to the customer application or customer service while preventing any customer application or customer service for another customer from accessing that hardware protected key.

37. The compute platform of claim 36, wherein the hardware protected key comprises a Symmetric Wrapping Key (SWK), and wherein the compute platform is further configured to:
apply a symmetric cryptograph algorithm using the SWK to a private key blob to generate cipher text; and
append an authentication tag to the cipher text to generate a wrapped private key (WPK).

38. The compute platform of claim 36, further configured to:
implement a table including a plurality of entries, each entry including a unique identifier associated with an application or service instance and a key handle; and
enable an application or service instance associated with a unique identifier to only access entries in the table with a matching unique identifier.

39. The compute platform of claim 38, wherein the hardware components comprises a processor that is configured to execute software processes and associate a respective Process Address Space Identifier (PASID) for a software process, and wherein the unique identifier associated with an application or service comprises a Process Address Space Identifier (PASID).

40. The compute platform of claim 38, wherein the table comprises a first table and a key handle is used to access a hardware protected key stored on the hardware component with the per-part device key, and wherein the compute platform is further configured to:
implement a second table mapping service instances to key handles; and
enable a service instance to obtain a hardware protected key from the hardware component using the second table.

41. A device, comprising:
a permanent per-part device key; and
embedded logic to,
generate a Symmetric Wrapping Key (SWK) using the permanent per-part device key; and
enable secure access to the SWK.

42. The device of claim 41, further comprising embedded firmware configured to implement a hardcoded Elliptic-curve cryptography (ECC) parameters table including a curve identifier field and a curve parameters field.

43. The device of claim 41, wherein the device comprises one of a Graphic Processor Unit (GPU), a General Purpose GPU (GP-GPU), a Tensor Processing Unit (TPU), a Data Processor Unit (DPU), an Infrastructure Processing Unit (IPU), a SmartNIC (network interface controller), an Artificial Intelligence (AI) processor or an AI inference unit.

44. The device of claim 41, further comprising embedded logic to:
implement a Wrapping Key Table (WKT) including a plurality of WKT entries, wherein each WKT entry comprises a SWK and a unique identifier; and
enforce an access mechanism that employs the unique identifiers in the WKT entries to enable access to associated SWKs.

45. The device of claim 44, wherein the device comprises a central processing unit (CPU) that is configured to execute software processes and associate a respective Process Address Space Identifier (PASID) for a software process, and further where the unique identifiers in the WKT comprises PASIDs.

46. A non-transitory machine-readable medium having instruction stored thereon configured to be executed on a processor in a compute platform including one or more hardware devices with a permanent per-part device key and configured to generate one or more Symmetric Wrapping Keys (SWKs) using the permanent per-part device key and store the one or more SWKs on the hardware device, wherein execution of the instructions enables the compute platform to:
provision an SWK for a service instance; and
enable only the service instance for which the SWK is provisioned to access the SWK.

47. The non-transitory machine-readable medium of claim 46, wherein the instructions comprise a shim layer operating as an API (Application Program Interface) adaptor between a cryptographic library and a key protection service API.

48. The non-transitory machine-readable medium of claim 46, wherein the instructions are implemented in one of a host operating system, a Virtual Machine Monitor (VMM), a hypervisor, a virtual machine (VM), or a container.

49. The non-transitory machine-readable medium of claim 46, wherein execution of the instructions on the processor further enables the compute platform to:
generate a service instance—key handle mapping table comprising a service instance field and a key handle field; and
in conjunction with allocating an SWK to the service instance, adding an entry to the service instance—key handle mapping table including an identifier associated with the service instance and a key handle to the SWK.

50. The non-transitory machine-readable medium of claim 49, wherein the compute platform comprises a plurality of hardware devices configured with respective permanent per-part device keys and configured to generate one or more Symmetric Wrapping Keys (SWKs) using the hardware device's permanent per-part device key and store the one or more SWKs on the hardware device, wherein the service instance—key handle mapping table further includes a device field, and wherein execution of the instructions further enables the compute platform to:
provision an SWK on one of the plurality of hardware devices for a service instance; and
add an entry to the service instance—key handle mapping table including an identifier associated with the service instance, a key handle to the SWK, and a device identifier in the device field that identifies the hardware device.
